(19) United States
(12) Patent Application Publication
(10) Pub. No.: US 2003/0209313 A1
(43) Pub. Date: Nov. 13, 2003

(54) Method and apparatus for mechanically embossing a surface covering

(76) Inventor: Brent Stoll, Lititz, PA (US)

Correspondence Address: Womble Carlyle Sandridge & Rice, PLLC, P.O. Box 7037, Atlanta, GA, 30357-0037, US

(21) Appl. No.: 10/143,058

(22) Filed: May 10, 2002

(51) Int. Cl. B32B 31/00

(52) U.S. Cl. 156/209; 156/277

(57) ABSTRACT

Disclosed is both a method and apparatus for mechanically embossing a decorative covering. The decorative covering includes a printed film that is laminated and mechanically embossed with a first embossed pattern/texture, and subsequently embossed with a second pattern/texture. The embossed patterns are applied at separate embossing stations, with the first embossed pattern as a field pattern and the latter pattern being embossed in register with a pattern on the embossed substrate.

### FIELD OF THE INVENTION

The present invention relates generally to surface coverings and in particular to a method and apparatus for mechanically embossing a surface covering using separate embossing stations.

### BACKGROUND

Decorative surface coverings can be formed into sheets or individual tiles. Typically, in the manufacture of a resilient surface covering, a wear layer is combined with a substrate and resin to form the resilient sheet or tile. The substrate usually comprises a felted or matted fibrous substrate of overlapping, intertwined filaments or fibers. A substantially uniform layer of a liquid or semi-liquid resinous composition containing a synthetic polymeric material, usually an ungelled polyvinyl chloride plastisol and a blowing or foaming agent is typically applied to the substrate. The liquid or semi-liquid plastisol vinyl resin composition is subsequently firmed or gelled at an elevated temperature. This gelled plastisol may be printed with a decorative pattern or design having a blowing or foaming inhibitor for chemically embossing the foam layer. A wear layer is applied to the print layer and the composite is heated at high temperature to fuse the polymer and expand the foam layer in the uninhibited regions to produce chemically embossed, foamed sheet flooring products.

Typically, a texture may be either mechanically embossed by pressing a pattern/texture into the surface covering or chemically embossed by using foam retarding agents to restrict expansion of a foamable layer in specific regions of the design. Furthermore, both methods may be used in combination.

Mechanical embossing is the earlier of the two described embossing methods and requires the use of suitably engraved or etched plates or rolls which press against and into a resinous product or surface covering under relatively great pressure to obtain a desired embossed decorative or textured surface. An embossing roll or plate can only impart an embossed pattern corresponding to the etched or engraved pattern on the plate or roll. Often, the engraved pattern is made to create an embossed decorative texture that is in register with a printed design located on the surface covering. Additionally, the use of two embossing rolls to impart two mechanical textures to these foamed sheet products may be used. However, the first embossing roll has no impact on registration control of the second mechanical embossing station that embosses in register with the printed pattern.

Alternatively, a surface covering may be both mechanically and chemically embossed. Chemical and mechanical embossing includes coating a backing layer with a foamable layer, and adding a print layer to it. The print layer forms a design and a portion of the design is formed with a retarder composition. A thermoplastic wear layer is applied onto the print layer and cured by heat at a temperature sufficiently high enough to expand the foamable layer. The areas of the design layer where the retarder composition is applied are also chemically embossed during such curing. The wear layer is then mechanically embossed to have a surface texture in the wear layer overlying the unrestricted/up areas. Optionally, a top coat can be applied to the wear layer before curing and expanding the foam, and the top coat can be mechanically embossed.

Furthermore, residential tile patterns may be embossed in register using a two nip process. This process can include a back printed rigid vinyl film laminated in a first nip to the substrate (filled polymer layer) using a smooth laminator roll and then further embossed at a second nip using an engraved embossing roll. The first laminator roll is used to control the print repeat pattern on the back printed film for registration control at the second nip. Unfortunately, under this process when trying to achieve the proper field texture depth, the process produces a distorted, less detailed image on the tile.

### SUMMARY

The present invention comprises a method and apparatus for manufacturing a decorative covering which is mechanically embossed having a first and second embossed pattern, wherein the first embossing station also functions to laminate a printed film to the substrate. The embossed patterns are applied at separate embossing stations, with the first embossed pattern as a field pattern and the latter pattern being embossed in register with a pattern on the embossed substrate.

In one embodiment, the printed film comprises a back printed pattern on the film. In a second embodiment, the first embossing nip also functions to help control dimensions of the printed image on the film for mechanical embossing in register at the second nip.

In a further embodiment, a method for manufacturing a decorative surface covering includes calendering a heated thermoplastic to form substrate and applying a printed film onto the substrate and embossing the substrate with the applied film with a first pattern at a first embossing station. Then embossing a second pattern on the substrate at a second embossing station. The method further includes back printing a design on the printed film and embossing the second pattern in register with the printed design.

A further embodiment includes a method for manufacturing a decorative surface covering including the steps of calendering into a substrate a heated thermoplastic and transferring the substrate to an upper portion of a drum. The method further includes applying a printed film onto the substrate and embossing the substrate with the applied film with a first pattern at a first embossing station and embossing a second pattern on the substrate at a second embossing station. The step of embossing a second pattern on the substrate at a second embossing station typically includes passing the substrate with a laminated film through a second nip formed from a second embossing roll and the drum.

### BRIEF DESCRIPTION OF THE DRAWINGS

In the drawings:

FIG. 1 illustrates the dual nip embossing process for use with a drum; and

FIG. 2 illustrates a schematic diagram of the belted dual nip embossing process.

### DETAILED DESCRIPTION

The present invention comprises a method and apparatus for manufacturing a decorative covering having embossed a first and second embossed pattern. The method includes both a first and second embossed pattern applied at separated embossing stations or embossing rolls. The first embossed pattern can be applied with the application of a printed film to the substrate. The second embossed pattern may be embossed in register with a printed design of the printed film.

The method for manufacturing a decorative covering initially comprises forming a substrate that may be then laminated and embossed with a first and second embossed pattern. Essentially, the substrate can be formed of a resinious blend comprising a free-flowing homogeneous mixture of a thermoplastic vinyl resin, vinyl plasticizers, fillers, pigments, and a vinyl stabilizer. The fillers are typically inorganic matter and may include limestone, silica, diatornaceous earth, clay and mixtures thereof.

The method for manufacturing a decorative surface covering includes forming the covering on a drum or belt. The drum process is further described in U.S. No. 4,804,429, which is incorporated herein in its entirety by reference. When formed on a drum, the covering is formed by calendering into a substrate a heated thermoplastic and transferring the substrate to an upper portion of a drum. The method further includes applying a printed film onto the substrate and embossing the substrate with the applied film with a first pattern/texture at a first embossing station and embossing a second pattern/texture on the substrate at a second embossing station. The belt process is further described in U.S. Pat. No. 4,225,374, which is incorporated herein in its entirety by reference. The belt process includes calendering into a substrate, a heated thermoplastic and applying a printed film onto the substrate and embossing the substrate with the applied film with a first pattern at a first embossing station. Then embossing a second pattern on the substrate at a second embossing station.

Dual Nip Drum

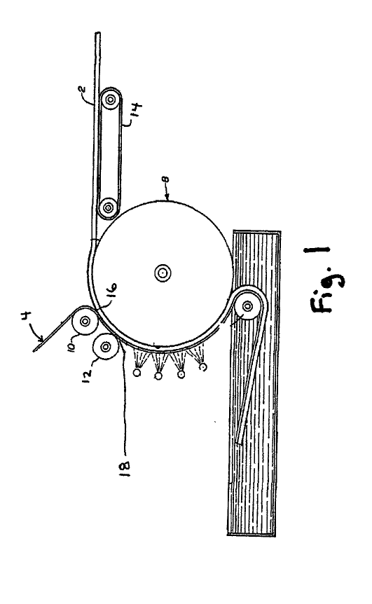

As illustrated in FIG. 1, the method of making a decorative covering includes forming the covering on a drum 8 including a resin mixture substrate 2 deposited on a conveyor 4, wherein the resin maybe composed of a vinyl resin. The resinious mixture substrate 2 is composed of at least a vinyl resin, plasticizer, and filler to form a surface tile material. The substrate 2 is transferred from the conveyor 14 to the surface of the upper portion of a large drum 8. One side of the substrate 2 engages the drum 8 at the upper portion of the drum. The temperature of the substrate is controlled since if the temperature is too high, the resin becomes very fluid and cannot be operated on by a conventional step for modifying the tile surface, for example, an embossing step.

After the substrate is positioned on the drum 8 surface, it is engaged by a first embossing roll 10. The first embossing roll 10 directly engages the substrate 2 and a film 4 such as a rigid vinyl film having a printed design. The film 4 is inserted between the first roll 10 and the exposed surface of the resin mixture substrate 2 on the surface of the drum 8. The drum 8 and the first roll 10 form a first nip 16 or space there between. In the first nip 16, the substrate 2 and the film 4 are laminated and embossed together. Additionally, this first embossing roll 10 can also be used to control the printed design repeat length and facilitate embossing in register control at the second nip 18. The first embossing roll 10 embosses the combined resinious film 4 and substrate 2 with an overall embossed design or field. A second embossing roll 12 provides a second embossed effect to the surface of the resinious mixture substrate containing the rigid vinyl film. The second embossed effect may be in register with the printed patter or design.

At the second nip 18, there is formed a film/substrate composite which is embossed at the time the substrate passes between the second nip 18 formed from the second roll 12 and the drum 8. The substrate adheres to the drum surface and passes through the nip without movement of the resinious substrate material with regard to the drum 8. The rigid resinious film 4 is called a “rigid” film because it has a plasticizer level of up to about 3%. The rigid resinious film is any conventional resinious film being approximately 3 mils thick and the resinious mixture substrate is approximately 42 mils thick.

Dual Nip Belt

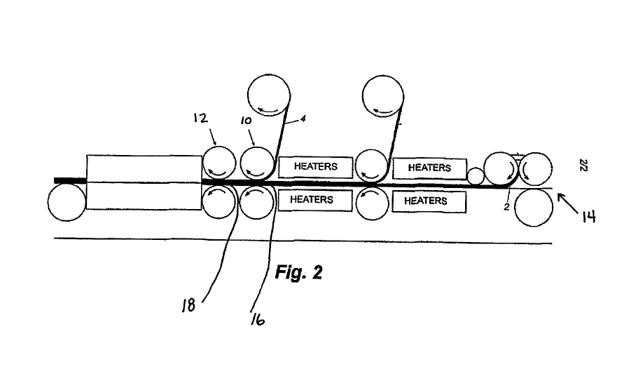

As shown in FIG. 2, the method of making a decorative covering includes forming the covering on a belt process including depositing heated chips or a mass of small particles of thermoplastic material from a hopper into a calender structure. A knife then strips the calendered substrate from the roll and deposits it upon the upper surface of a nondistensible controlled belt release carrier 14. The substrate 2 of consolidated thermoplastic material is then moved past conventional heaters to achieve the correct temperature for adherence to the nondistensible controlled release belt carrier 14.

After the substrate is positioned on the belt 14, it is engaged by a first embossing roll 10. The first embossing roll directly engages the substrate 2 and the rigid vinyl film 4 with a printed design. The film 4 is inserted between the first roll 10 and the exposed surface of the resinious mixture substrate on the surface of the belt 14. The belt 14 and the first roll 10 form a first nip 16 or space there between. In the first nip 16, the substrate 2 and the film 4 are laminated and embossed together. The first embossing roll 10 laminates and embosses the substrate 2 to the upper surface of the resinious film 4 at the first nip 16 between the first roll 10 and belt 14. Additionally, this first embossing nip 16 can also be used to control the printed design repeat length and facilitate embossing in register control at the second nip 18. The first embossing roll 10 embosses the combined vinyl film 4 and substrate 2 with an overall embossed design or field. A second embossing roll 12 provides a second embossed effect to the surface of the resinious mixture substrate containing the rigid vinyl film 4. The second embossed effect may be in register with the printed patter or design.

Essentially, the use of an embossing roll instead of the smooth laminating role has no effect on the ability of the first nip to help control registration at the second nip embossing station. The second embossed pattern may be mechanically embossed in register at the second station using an upper embossing roll and a lower rubber roll.

While specific embodiments have been set forth as illustrated and described above, it is recognized that variations may be made with respect to disclosed embodiments. Therefore, while the invention has been disclosed in various forms only, it will be obvious to those skilled in the art that many additions, deletions and modifications can be made without departing from the spirit and scope of this invention, and no undue limits should be imposed except as set forth in the following claims.

What is claimed is:

1. A method for manufacturing a decorative surface covering comprising:
forming a substrate;
applying a printed film and embossing a first pattern on the substrate at a first embossing station; and
embossing a second pattern on the substrate at a second embossing station.

2. The method of claim 1, wherein the printed film comprises a back printed pattern.

3. The method of claim 1, wherein the second pattern is embossed in register with a printed design of the printed film.

4. The method of claim 1, wherein the film comprises a material selected from the group consisting of a polyvinyl chloride, a polyurethane, a polyester, a polyaminde, a polyolefin, a polyacrylate, and mixtures and co-polymers thereof.

5. The method of claim 1, wherein the first pattern is embossed as an overall pattern onto the substrate.

6. The method of claim 1, wherein the substrate is formed by calendering a heated mass of thermoplastic material.

7. The method of claim 1, further including printing a design on the substrate.

8. The method of claim 7, wherein the second pattern is embossed in register with the printed design on the substrate.

9. The method of claim 1, further including forming the decorative covering into individual tile units.

10. The method of claim 1, wherein the substrate comprises a foamed layer.

11. A method for manufacturing a decorative surface covering comprising:
calendering a heated thermoplastic material to form a substrate;
applying a printed film onto the substrate to form a film/substrate composite and embossing the composite with a first pattern at a first embossing station; and
embossing a second pattern on the composite at a second embossing station.

12. The method of claim 11, further including back printing a design on the printed film and embossing the second pattern in register with the printed design.

13. The method of claim 12, further including cutting the composite in register with the printed design.

14. The method of claim 11, further including transfer printing the substrate before applying the film and embossing the second pattern in register with the design.

15. A method for manufacturing a decorative surface covering comprising:
calendering into a substrate a heated thermoplastic;
transferring the substrate to a drum;
applying a printed film onto the substrate to form a film/substrate composite and embossing the composite with a first pattern at a first embossing station by passing the film and substrate through a first nip formed from a first embossing roll and the drum; and
embossing a second pattern on the substrate at a second embossing station.

16. The method of claim 15, wherein the step of embossing a second pattern on the substrate at a second embossing station comprises passing the substrate with a laminated film through a second nip formed from a second embossing roll and the drum.

17. The method of claim 15, further including back printing a design on the printed film and embossing the second pattern in register with the printed design.

18. The method of claim 17, further including cutting the substrate in register with the printed design.
